(19) United States
(12) Patent Application Publication
(10) Pub. No.: US 2025/0306664 A1
(43) Pub. Date: Oct. 2, 2025

(54) SELECTING LOW-POWER MODES (LPMs) BASED ON MONITORING INTER-PROCESSOR INTERRUPT (IPI) ARRIVAL INTERVALS IN PROCESSOR DEVICES

(71) Applicant: QUALCOMM Incorporated, San Diego, CA (US)

(72) Inventors: Maulik Shah, Hyderabad (IN); Srinivas Rao Lengamaneni, Hyderabad (IN); Nirav Narendra Desai, Hyderabad (IN); Dinesh Kumar Choudhary, Tonk (IN); Raja Simha Revanuru, Hyderabad (IN)

(21) Appl. No.: 18/618,132

(22) Filed: Mar. 27, 2024

(51) Int. Cl. G06F 1/324

(52) U.S. Cl. CPC G06F 1/324

(57) ABSTRACT

Selecting low-power modes (LPMs) based on monitoring inter-processor interrupt (IPI) arrival intervals in processor devices is disclosed herein. In some aspects, a processor device comprises a plurality of processor elements (PEs) and an LPM selection circuit. The LPM selection circuit is configured to determine an average IPI arrival interval for a PE of the plurality of PEs based on an IPI arrival history table for the PE. The LPM selection circuit then determines whether the average IPI arrival interval is greater than a minimum residency interval for a first LPM of the PE, wherein the first LPM is associated with lower power consumption and higher entry and exit latency relative to a second LPM of the PE. If so, the LPM selection circuit places the PE in the first LPM; otherwise, the LPM selection circuit places the PE in the second LPM.

### TECHNICAL FIELD

The technology of the disclosure relates generally to power management in multicore processor devices, and, in particular, to selection of low-power modes (LPMs) for processor cores and/or core clusters of a processor device.

### BACKGROUND

Conventional processor devices may be implemented as multiple processing units, or “processor cores,” that can be organized into core clusters. Each processor core is configured to independently fetch, decode, and execute computer instructions to manipulate and store data. Because multicore processor devices can execute instructions on multiple processor cores simultaneously, the performance of software that supports parallel computing techniques such as multithreading may be improved when executing on such devices.

To help manage power consumption, a multicore processor device may be configured to enter a low-power mode (LPM) to save energy during idle periods. An LPM may be applied to one or more individual processor cores, or to an entire core cluster of the multicore processor device. A power management circuit of the multicore processor device may provide support for multiple LPMs, each of which provides a different level of power savings and incurs a different latency and energy overhead when a processor core or a core cluster enters and exits the LPM. For example, clock gating (referred to as “C1”) is an LPM that, when applied to a processor core or a core cluster, causes the main internal clocks of the processor core or the core cluster to be stopped while other elements such as bus interfaces and interrupt controllers continue to run. In contrast, power collapse (referred to as “C4”) is an LPM that involves reducing voltage to all elements of a processor core or a core cluster. The power collapse LPM is considered a “deeper” LPM than the “shallower” clock gating LPM, in that it reduces the functionality of the processor device further and produces higher power savings relative to the clock gating LPM. However, the power collapse LPM requires more time to enter into and exit from, resulting in greater latency and energy overhead than the clock gating LPM.

The use of deeper LPMs such as the power collapse LPM is a useful technique for reducing a multicore processor device's overall power consumption. To fully realize the benefits of a deeper LPM, though, the processor device must remain in the LPM for a long enough time period that the energy saved by placing the processor device in the LPM is greater than the energy overhead of entering into and exiting from the LPM. This time period is referred to herein as a “minimum residency interval” for the LPM. When tasks to be executed by a processor core or a core cluster are scheduled in a predictable fashion, the expected idle times of the processor core or the core cluster are likewise more predictable. This simplifies the task of selecting an appropriate LPM for use during the idle times to ensure that the processor will remain in the LPM for the duration of the corresponding minimum residency interval.

However, in applications that execute across multiple processor cores and/or core clusters, work coordination among the different processor cores may be accomplished using inter-processor interrupts (IPIs) sent by one processor core to another at generally non-deterministic intervals. The arrival of an IPI at a processor core that is presently in an LPM triggers an asynchronous wakeup event that causes that processor core to exit from the LPM. If the IPI arrives before the end of the minimum residency interval for the LPM, the processor core may be forced to prematurely exit from the LPM. In the case of deeper LPMs such as the power collapse LPM, such premature exits can negate the power-saving benefits of the LPM because the energy overhead incurred in entering and exiting the LPM is greater than the energy saved during the period in which the processor core was in the LPM.

Accordingly, a mechanism for reducing the probability of premature exits from deeper LPMs is desirable.

### SUMMARY OF THE DISCLOSURE

Aspects disclosed in the detailed description include selecting low-power modes (LPMs) based on monitoring inter-processor interrupt (IPI) arrival intervals in processor devices. Related apparatus, methods, and computer-readable media are also disclosed. In this regard, a processor device comprises a plurality of processing elements (PEs) (e.g., a plurality of processor cores or a plurality of core clusters, as non-limiting examples). The processor device further includes an LPM selection circuit that is configured to monitor the arrival of IPIs at each PE, and select an appropriate LPM for the PE based on the monitored IPI arrivals. When selecting an appropriate LPM, the LPM selection circuit determines an average IPI arrival interval for the PE based on an IPI arrival history table for the PE. This may be performed, e.g., in response to the LPM selection circuit identifying an arrival interval pattern in the IPI arrival history table.

The LPM selection circuit then determines whether the average IPI arrival interval is greater than a minimum residency interval for a first LPM of the PE, where the first LPM is associated with lower power consumption and higher entry and exit latency relative to a second LPM of the PE (i.e., the first LPM is “deeper” than the second LPM). If the LPM selection circuit determines that the average IPI arrival interval is greater than the minimum residency interval for the first LPM, the LPM selection circuit places PE in the first LPM. This may involve, e.g., setting an LPM interval for the first LPM to the lesser of the average IPI arrival interval and a next scheduled task interval. However, if the LPM selection circuit determines that the average IPI arrival interval is not greater than the minimum residency interval for the first LPM, the LPM selection circuit places the PE in the second LPM. In some aspects, the IPI arrival history table is populated by the LPM selection circuit detecting an IPI received by the PE, determining an IPI arrival interval for the IPI based on an arrival time of the IPI and an arrival time of a previous IPI, and storing the IPI arrival interval in the IPI arrival history table.

In another aspect, a processor device is provided. The processor device comprises a plurality of PEs and an LPM selection circuit. The LPM selection circuit is configured to determine an average IPI arrival interval for a PE of the plurality of PEs based on an IPI arrival history table for the PE. The LPM selection circuit is further configured to determine whether the average IPI arrival interval is greater than a minimum residency interval for a first LPM of the PE, wherein the first LPM is associated with lower power consumption and higher entry and exit latency relative to a second LPM of the PE. The LPM selection circuit is also configured to, responsive to determining that the average IPI arrival interval is greater than the minimum residency interval for the first LPM, place the PE in the first LPM. The LPM selection circuit is additionally configured to, responsive to determining that the average IPI arrival interval is not greater than the minimum residency interval for the first LPM, place the PE in the second LPM.

In another aspect, a method for selecting LPMs based on monitoring IPI arrival intervals in processor devices is provided. The method comprises determining, by an LPM selection circuit of a processor device, an average IPI arrival interval for a PE of a plurality of PEs of the processor device based on an IPI arrival history table for the PE. The method further comprises determining, by the LPM selection circuit, that the average IPI arrival interval is greater than a minimum residency interval for a first LPM of the PE, wherein the first LPM is associated with lower power consumption and higher entry and exit latency relative to a second LPM of the PE. The method also comprises, responsive to determining that the average IPI arrival interval is greater than the minimum residency interval for the first LPM, placing, by the LPM selection circuit, the PE in the first LPM.

In another aspect, a non-transitory computer-readable medium is disclosed. The non-transitory computer-readable medium stores computer-executable instructions that, when executed, cause a processor device to determine an average IPI arrival interval for a PE of a plurality of PEs of the processor device based on an IPI arrival history table for the PE. The computer-executable instructions further cause the processor device to determine whether the average IPI arrival interval is greater than a minimum residency interval for a first LPM of the PE, wherein the first LPM is associated with lower power consumption and higher entry and exit latency relative to a second LPM of the PE. The computer-executable instructions also cause the processor device to, responsive to determining that the average IPI arrival interval is greater than the minimum residency interval for the first LPM, place the PE in the first LPM. The computer-executable instructions additionally cause the processor device to, responsive to determining that the average IPI arrival interval is not greater than the minimum residency interval for the first LPM, place the PE in the second LPM.

### BRIEF DESCRIPTION OF THE FIGURES

FIG. 1 is a diagram illustrating a conventional timeline of entry into and exit from a low-power mode (LPM) by a processor device, according to some aspects;

FIG. 2 is a block diagram illustrating an exemplary processor device that includes an LPM selection circuit configured to select LPMs based on monitoring inter-processor interrupt (IPI) arrival intervals, according to some aspects;

FIG. 3 is a block diagram illustrating in greater detail exemplary elements of the IPI arrival history tables of FIG. 2, according to some aspects;

FIG. 4 provides a flowchart illustrating exemplary operations performed by the LPM selection circuit of FIG. 2 for selecting LPMs based on monitoring IPI arrival intervals, according to some aspects; and

FIG. 5 is a block diagram of an exemplary processor-based device that can include the processor device of FIG. 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like are used herein to distinguish between similarly named elements, and are not to be interpreted as indicating an ordinal relationship between such elements unless expressly described as such herein.

Aspects disclosed in the detailed description include selecting low-power modes (LPMs) based on monitoring inter-processor interrupt (IPI) arrival intervals in processor devices. Related apparatus, methods, and computer-readable media are also disclosed. In this regard, a processor device comprises a plurality of processing elements (PEs) (e.g., a plurality of processor cores or a plurality of core clusters, as non-limiting examples). The processor device further includes an LPM selection circuit that is configured to monitor the arrival of IPIs at each PE, and select an appropriate LPM for the PE based on the monitored IPI arrivals. When selecting an appropriate LPM, the LPM selection circuit determines an average IPI arrival interval for the PE based on an IPI arrival history table for the PE. This may be performed, e.g., in response to the LPM selection circuit identifying an arrival interval pattern in the IPI arrival history table.

The LPM selection circuit then determines whether the average IPI arrival interval is greater than a minimum residency interval for a first LPM of the PE, where the first LPM is associated with lower power consumption and higher entry and exit latency relative to a second LPM of the PE (i.e., the first LPM is “deeper” than the second LPM). If the LPM selection circuit determines that the average IPI arrival interval is greater than the minimum residency interval for the first LPM, the LPM selection circuit places PE in the first LPM. This may involve, e.g., setting an LPM interval for the first LPM to the lesser of the average IPI arrival interval and a next scheduled task interval. However, if the LPM selection circuit determines that the average IPI arrival interval is not greater than the minimum residency interval for the first LPM, the LPM selection circuit places the PE in the second LPM. In some aspects, the IPI arrival history table is populated by the LPM selection circuit detecting an IPI received by the PE, determining an IPI arrival interval for the IPI based on an arrival time of the IPI and an arrival time of a previous IPI, and storing the IPI arrival interval in the IPI arrival history table.

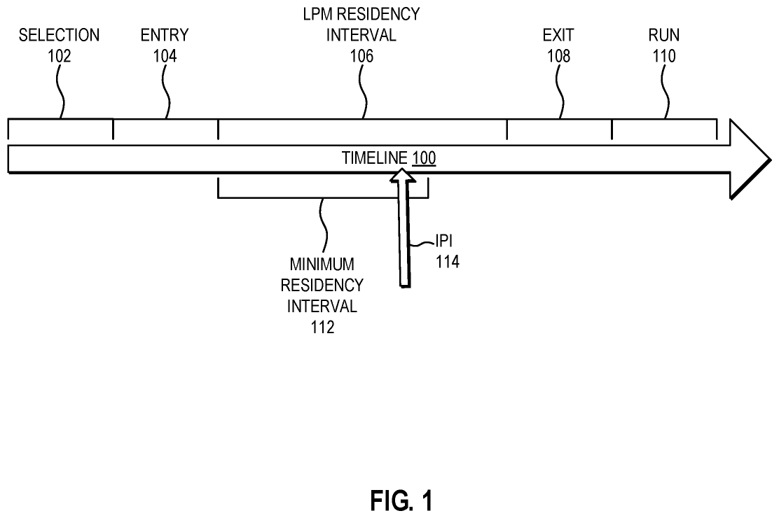

Before discussing exemplary operations for selecting LPMs based on monitoring IPI arrival intervals, a conventional timeline for entering and exiting an LPM by a PE (i.e., a processor core or a core cluster) is first discussed. In this regard, FIG. 1 shows an exemplary timeline 100 representing a passage of time, with earlier events on the left side of the timeline 100 and later events on the right side of the timeline 100. Upon determining to enter an LPM, a PE (not shown) first performs an LPM selection operation (captioned as “SELECTION” in FIG. 1) 102. During the LPM selection operation, the PE determines which of multiple supported LPMs (e.g., a clock gating LPM, a power collapse LPM, and the like, as non-limiting examples) is most appropriate for the current operating conditions of the PE. In making this determination, the PE may consider such factors as Quality-of-Service (QOS) requirements, known timer events, specified LPM parameters, and the like, as non-limiting examples. For example, if a QoS requirement specifies that the PE needs to provide a high level of availability, the PE may opt for a shallower LPM to minimize latency when entering and exiting the LPM.

Once an appropriate LPM is determined, the PE then begins LPM entry operations (captioned as “ENTRY” in FIG. 1) 104 into the LPM. The LPM entry operations 104 may comprise operations such as storing system state, changing clock frequency and/or voltage for the PE, and/or turning off elements of the PE, as non-limiting examples. As a general rule, the deeper the LPM, the longer the LPM entry operations 104 may take and the more energy may be consumed by the PE in performing the LPM entry operations 104.

After the PE has entered the LPM, the LPM residency interval 106 begins. The LPM residency interval 106 represents the period of time during which the PE remains in the LPM. The LPM residency interval 106 may end when a specified LPM interval (i.e., a “sleep length”) ends, or when a timer event or an IPI occurs. At the end of the LPM residency interval 106, LPM exit operations (captioned as “EXIT” in FIG. 1) 108 are performed to return the PE to its previous clock and power states, and to restore system state if necessary. Like the LPM entry operations 104, the LPM exit operations 108 for deeper LPMs may take longer to perform and may consume more energy than shallower LPMs. Finally, after the LPM exit operations 108, execution (captioned as “RUN” in FIG. 1) 110 of a next scheduled task is performed by the PE.

As noted above, to fully realize the benefits of an LPM, the LPM residency interval 106 must be at least as long as a minimum residency interval 112 for the LPM. As used herein, the “minimum residency interval” refers to a time interval during which the energy saved by placing the PE in the LPM exceeds the combined energy overhead of the LPM entry operations 104 and the LPM exit operations 108. If an IPI 114 arrives at the PE before the minimum residency interval 112 has elapsed, a premature exit from the LPM may be triggered. Such premature exits can negate the power-saving benefits of the LPM because the energy overhead incurred by the LPM entry operations 104 and the LPM exit operations 108 for the LPM exceed than the energy saved during the LPM residency interval 106 for the LPM. This is particularly a concern with deeper LPMs such as the power collapse LPMs, because the minimum residency interval 112 is longer and thus more likely to overlap with the arrival of the IPI 114.

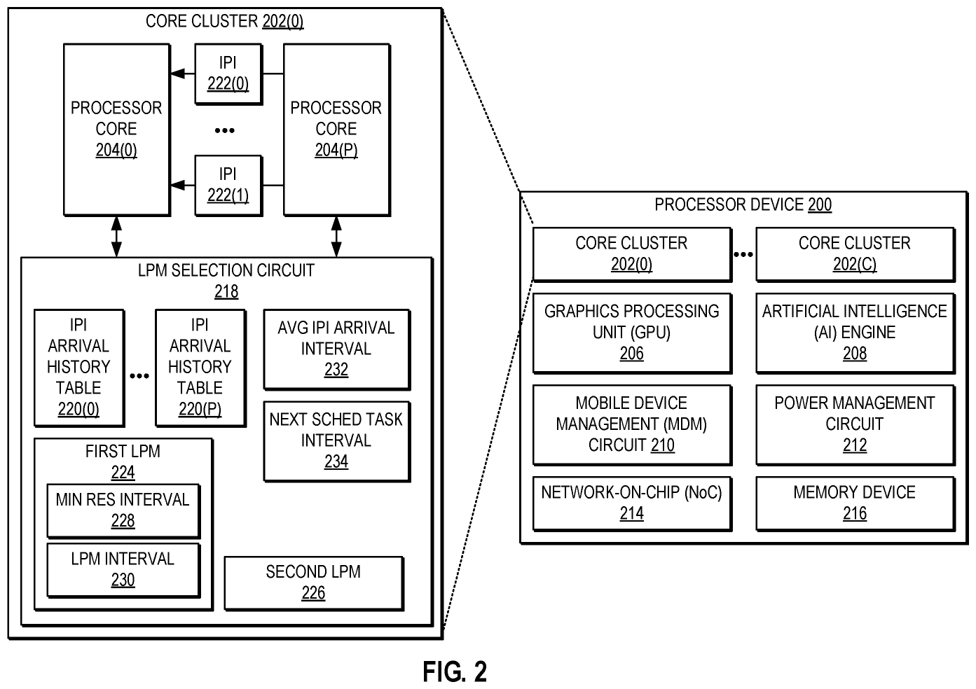

In this regard, FIG. 2 is a block diagram of an exemplary processor device 200 (also referred to a “processor” or a “CPU”) that is configured to select LPMs based on monitoring IPI arrival intervals. In particular, the processor device 200 is configured to perform the LPM selection operation 102 of FIG. 1 by selecting a deeper LPM only if an IPI is not expected to arrive within the minimum residency interval 112 for the deeper LPM, and otherwise selecting a shallower LPM. The processor device 200 may comprise an in-order or an out-of-order processor (OoP), and/or may be one of a plurality of processor devices 200. Examples of the processor device 200 may include, but are not limited to, a digital signal processor (DSP), general-purpose microprocessor, application specific integrated circuit (ASIC), field programmable logic array (FPGA), or other equivalent integrated or discrete logic circuitry.

As seen in FIG. 2, the processor device 200 comprises a plurality of core clusters 202 (0)-202 (C), each of which comprises a plurality of processor cores such as the processor cores 204 (0)-204 (P) of the core cluster 202 (0). The processor device 200 in the example of FIG. 2 also comprises a graphics processing unit (GPU) 206 for performing graphical operations. As a non-limiting example, the GPU 206 may comprise a dedicated hardware unit having fixed functionality and programmable components for rendering graphics and executing GPU applications. The GPU 206 may also include a DSP, general-purpose microprocessor, ASIC, FPGA, or other equivalent integrated or discrete logic circuitry, which are not shown in FIG. 2 for the sake of clarity.

The processor device 200 in the example of FIG. 2 further comprises additional exemplary elements, including an artificial intelligence (AI) engine 208, a mobile device management (MDM) circuit 210, a power management circuit 212, a network-on-chip (NoC) 214, and a memory device 216. The AI engine 208 of the processor device 200 comprises circuitry and logic for providing AI-based functionality such as search, speech recognition, text and/or image generation, and the like, as non-limiting examples. The MDM circuit 210 provides functionality for provisioning, configuring, updating, and/or securing a mobile device into which the processor device 200 is integrated. The power management circuit 212 provides high-level performance and power management functionality for the processor device 200 as a whole, while the NoC 214 is configured to manage communications between the different devices that comprise the processor device 200. Finally, the memory device 216 provides storage of and access to data used by the processor device 200, and, in some aspects, may comprise a Double Data Rate (DDR) Synchronous Dynamic Random-Access Memory (SDRAM) device, as a non-limiting example.

FIG. 2 also illustrates exemplary elements of the core cluster 202 (0) in greater detail. In the example of FIG. 2, the processor cores 204 (0)-204 (P) of the core cluster 202 (0) are communicatively coupled to an LPM selection circuit 218 that comprises a plurality of IPI arrival history tables 220 (0)-220 (P). Each of the IPI arrival history tables 220 (0)-220 (P) corresponds to a processor core of the plurality of processor cores 204 (0)-204 (P), and is used by the LPM selection circuit 218 to log IPI arrival intervals for that processor core. The processor cores 204 (0)-204 (P) may also be generally referred to herein as “processing elements” or “PEs.” It is to be understood that, while FIG. 2 only shows exemplary elements of the core cluster 202 (0), each of the core clusters 202 (0)-202 (C) include elements corresponding to the illustrated elements of the core cluster 202 (0). It is to be further understood that, while not shown in FIG. 2 for the sake of clarity, the processor device 200 may also or alternatively comprise an LPM selection circuit that is communicatively coupled to the core clusters 202 (0)-202 (C) and that comprises a plurality of IPI arrival history tables that each corresponds to a core cluster of the plurality of core clusters 202 (0)-202 (C). The functionality and operation of such an LPM selection circuit in such aspects would correspond to the operations and functionality of the LPM selection circuit 218 described herein. In such aspects, the core clusters 202 (0)-202 (C) may be generally referred to as “processing elements” or “PEs.” Additionally, while the LPM selection circuit 218 of FIG. 2 is illustrated as a standalone element, some aspects may provide that the LPM selection circuit 218 is integrated into the power management circuit 212 and/or into another element of the core cluster 202 (0) or the processor device 200.

The core cluster 202 (0) may execute applications using multiple processor cores such as the processor core 204 (0) and the processor core 204 (P). To coordinate workloads across the processor cores 204 (0) and 204 (P), IPIs may be transmitted and received by the processor cores 204 (0) and 204 (P) over a communications bus (not shown) at generally non-deterministic intervals. In the example of FIG. 2, an IPI 222 (0) arrives at the processor core 204 (0) from the processor core 204 (P) at a first time, and an IPI 222 (1) arrives at the processor core 204 (0) from the processor core 204 (P) at a later second time. Each of the IPIs 222 (0), 222 (1) is associated with a corresponding timestamp (not shown) indicating a time of arrival at the processor core 204 (0).

The LPM selection circuit 218 of FIG. 2 is configured to manage power consumption of each of the processor cores 204 (0)-204 (P) by placing them in one of a first LPM 224 and a second LPM 226 when the processor cores 204 (0)-204 (P) are idle. In the example of FIG. 2, the first LPM 224 is associated with lower power consumption and higher entry and exit latency relative to the second LPM 226. In some aspects, the first LPM 224 may comprise a power collapse LPM, while the second LPM 226 may comprise a clock gating LPM. It is to be understood that the LPM selection circuit 218 of FIG. 2 may support additional LPMs in addition to the first LPM 224 and the second LPM 226. As seen in FIG. 2, the first LPM 224 is associated with a minimum residency interval (captioned as “MIN RES INTERVAL” in FIG. 2) 228 that corresponds to the minimum residency interval 112 of FIG. 1. The first LPM 224 is also associated with an LPM interval 230 that defines a maximum time period during which a processor core 204 (0)-204 (P) will remain in the first LPM 224 if not otherwise woken.

The processor device 200 of FIG. 2 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that some aspects of the processor device 200, the core cluster 202 (0), and/or the processor cores 204 (0)-204 (P) may include elements in addition to or instead of those illustrated in FIG. 2, and/or may include more or fewer of the elements illustrated in FIG. 2. For example, the processor device 200 may further include caches, controllers, communications buses, and/or persistent storage devices, which are omitted from FIG. 2 for the sake of clarity.

As discussed above with respect to FIG. 1, if a PE such as the processor core 204 (0) is in an LPM such as the first LPM 224, it will realize energy savings only if it remains in the first LPM 224 at least as long as the minimum residency interval 228 for the first LPM 224 (to ensure that the energy saved by placing the processor core 204 (0) in the first LPM 224 exceeds the combined energy overhead of entering and exiting the first LPM 224). However, the arrival of an IPI such as the IPI 222 (1) while the processor core 204 (0) is in the first LPM 224 may trigger a premature exit from the first LPM 224, thereby negating the power-saving benefits of the first LPM 224.

Accordingly, when it is determined that the processor core 204 (0) is or will be idle, the LPM selection circuit 218 is configured to select an LPM from among the first LPM 224 and the second LPM 226 based on monitored IPI arrival intervals (i.e., the time periods between the arrival of IPIs such as the IPI 222 (0) and 222 (1)) at the processor core 204 (0). In exemplary operation, the LPM selection circuit 218 determines an average IPI arrival interval (captioned as “AVG IPA ARRIVAL INTERVAL” in FIG. 2) 232 for the processor core 204 (0) based on the IPI arrival history table 220 (0) for the processor core 204 (0). The LPM selection circuit 218 then determines whether the average IPI arrival interval 232 is greater than the minimum residency interval 228 for the first LPM 224. If so, this indicates that the arrival of a next IPI is expected to occur after the end of minimum residency interval 228, and the processor core 204 (0) is expected to receive an energy-saving benefit from the first LPM 224. The LPM selection circuit 218 thus places the processor core 204 (0) in the first LPM 224. In some aspects, placing the processor core 204 (0) in the first LPM 224 may involve, e.g., setting the LPM interval 230 for the first LPM 224 to the lesser of the average IPI arrival interval 232 and a next scheduled task interval (captioned as “NEXT SCHED TASK INTERVAL” in FIG. 2) 234 representing a time period before the processor core 204 (0) is scheduled to execute a task again.

However, if the LPM selection circuit 218 determines that the average IPI arrival interval 232 is not greater than the minimum residency interval 228 for the first LPM 224, this indicates that a next IPI is expected to arrive before the end of the minimum residency interval 228, and therefore the processor core 204 (0) is likely to exit prematurely from the first LPM 224. Accordingly, in this case, the LPM selection circuit 218 places the processor core 204 (0) in the second LPM 226 (i.e., the “shallower” LPM).

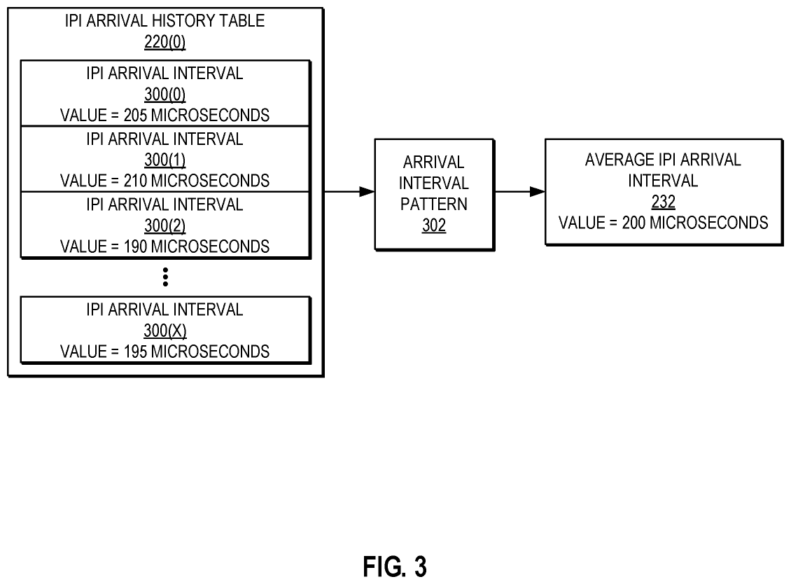

In some aspects, the LPM selection circuit 218 is configured to populate the IPI arrival history table 220 (0) in response to detecting the arrival of an IPI such as the IPI 222 (1). Thus, for example, the LPM selection circuit 218 determines an IPI arrival interval (not shown) for the IPI 222 (1) based on an arrival time of the IPI 222 (1) and an arrival time of a previous IPI (e.g., the IPI 222 (0)). The LPM selection circuit 218 then stores the IPI arrival interval in an IPI arrival history table 220 (0) for the processor core 204 (0). The LPM selection circuit 218 according to some aspects may also be configured to identify an arrival interval pattern in the IPI arrival history table 220 (0). This may be accomplished using statistical analysis of the IPI arrival intervals stored in the IPI arrival history table 220 (0) to determine that IPIs such as the IPI 222 (0), 222 (1) are not arriving at random intervals. In such aspects, determining the average IPI arrival interval 232 may be performed responsive to identifying an arrival interval pattern in the IPI arrival history table 220 (0), as discussed below in greater detail with respect to FIG. 3. Determining the average IPI arrival interval 232 may entail, e.g., discarding outlier IPI arrival intervals whose values differ from a mean value by a degree that exceeds a predetermined threshold (not shown).

FIG. 3 is a block diagram illustrating in greater detail exemplary elements of the IPI arrival history table 220 (0) of FIG. 2, according to some aspects. As seen in FIG. 3, the IPI arrival history table 220 (0) stores a plurality of IPI arrival intervals 300 (0)-300 (X), each of which represents a time period between an arrival of an IPI such as the IPI 222 (1) of FIG. 2 and an arrival of a previous IPI such as the IPI 222 (0) of FIG. 2. Thus, in the example of FIG. 3, the IPI arrival interval 300 (0) has a value of 205 microseconds, the IPI arrival interval 300 (1) has a value of 210 microseconds, the IPI arrival interval 300 (2) has a value of 190 microseconds, and the IPI arrival interval 300 (X) has a value of 195 microseconds.

The LPM selection circuit 218, upon analyzing the contents of the IPI arrival history table 220 (0) to determine the average IPI arrival interval 232, may first determine whether an arrival interval pattern 302 exists. As noted above, this may entail applying statistical analysis to the IPI arrival intervals 300 (0)-300 (X) to ascertain whether the IPI arrival intervals 300 (0)-300 (X) are random. If the arrival interval pattern 302 is identified, the LPM selection circuit 218 may then determine the average IPI arrival interval 232. In this example, the average IPI arrival interval 232 is determined to be 200 microseconds. Accordingly, when selecting an LPM for the processor core 204 (0) in the example of FIG. 2, the LPM selection circuit 218 places the processor core 204 (0) in the first LPM 224 if the minimum residency interval 228 is less than 200 microseconds. Otherwise, the LPM selection circuit 218 places the processor core 204 (0) in the second LPM 226.

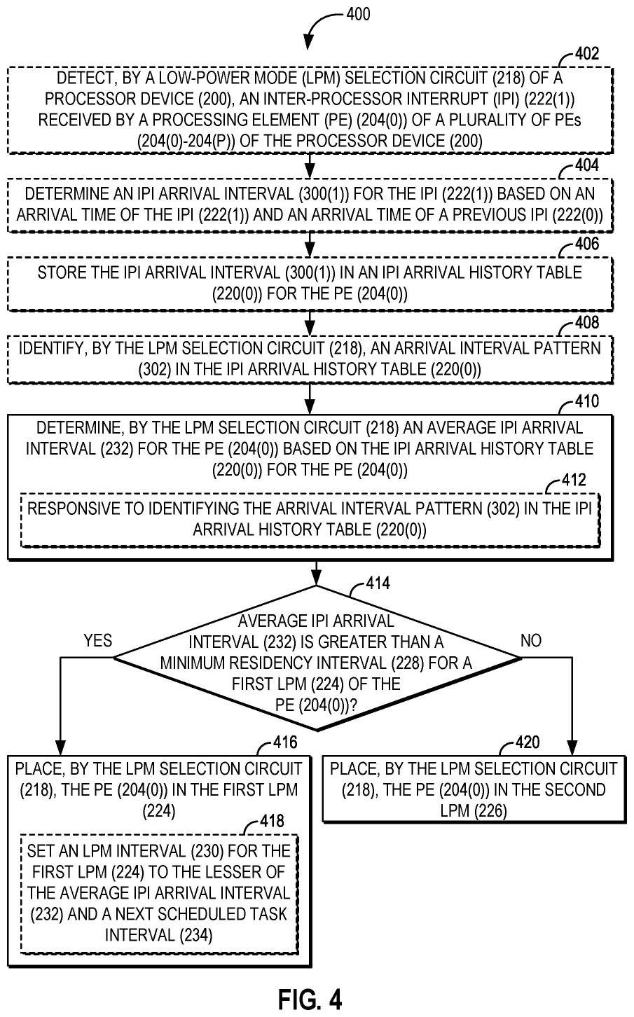

To illustrate exemplary operations of the LPM selection circuit 218 of FIG. 2 for selecting LPMs based on monitoring IPI arrival intervals according to some aspects, FIG. 4 provides a flowchart showing exemplary operations 400. Elements of FIGS. 2 and 3 are referenced in describing FIG. 4 for the sake of clarity. It is to be understood that some of the exemplary operations 400 shown in FIG. 4 may be performed in an order other than that illustrated herein in some aspects, and/or may be omitted in some aspects. As seen in FIG. 4, the exemplary operations 400 according to some aspects may begin with an LPM selection circuit of a processor device (e.g., the LPM selection circuit 218 of the processor device 200 of FIG. 2) detecting an IPI (such as the IPI 222 (1) of FIG. 2) received by a PE of a plurality of PEs (e.g., the processor core 204 (0) of the plurality of processor cores 204 (0)-204 (P) of FIG. 2) of the processor device 200 (block 402). The LPM selection circuit 218 in such aspects determines an IPI arrival interval (such as the IPI arrival interval 300 (1) of FIG. 3) for the IPI 222 (1) based on an arrival time of the IPI 222 (1) and an arrival time of a previous IPI (such as the IPI 222 (0) of FIG. 2) (block 404). The LPM selection circuit 218 then stores the IPI arrival interval 300 (1) in an IPI arrival history table (such as the IPI arrival history table 220 (0) of FIGS. 2 and 3) for the PE 204 (0) (block 406).

The LPM selection circuit 218 in some aspects may subsequently identify an arrival interval pattern (e.g., the arrival interval pattern 302 of FIG. 3) in the IPI arrival history table 220 (0) (block 408). The LPM selection circuit 218 determines an average IPI arrival interval (such as the average IPI arrival interval 232 of FIGS. 2 and 3) for the PE 204 (0) based on the IPI arrival history table 220 (0) for the PE 204 (0) (block 410). According to some aspects, the operations of block 410 for determining the average IPI arrival interval 232 may be performed responsive to identifying the arrival interval pattern 302 in the IPI arrival history table 220 (0) (block 412).

The LPM selection circuit 218 then determines whether the average IPI arrival interval 232 is greater than a minimum residency interval (e.g., the minimum residency interval 228 of FIG. 2) for a first LPM (such as the first LPM 224 of FIG. 2) of the PE 204 (0) (block 414). The first LPM 224 is associated with lower power consumption and higher entry and exit latency relative to a second LPM (such as the second LPM 226 of FIG. 2) of the PE 204 (0). If the LPM selection circuit 218 determines at decision block 414 that the average IPI arrival interval 232 is greater than the minimum residency interval 228 for the first LPM 224, the LPM selection circuit 218 places the PE 204 (0) in the first LPM 224 (block 416). According to some aspects, the operations of block 416 for placing the PE 204 (0) in the first LPM 224 may comprise the LPM selection circuit 218 setting an LPM interval 230 for the first LPM 224 to the lesser of the average IPI arrival interval 232 and a next scheduled task interval (e.g., the next scheduled task interval 234 of FIG. 2) (block 418). However, if the LPM selection circuit 218 determines at decision block 414 that the average IPI arrival interval 232 is not greater than the minimum residency interval 228 for the first LPM 224, the LPM selection circuit 218 places the PE 204 (0) in the second LPM 226 (block 420).

The processor device according to aspects disclosed herein and discussed with reference to FIGS. 2 and 3 may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, and a vehicle component.

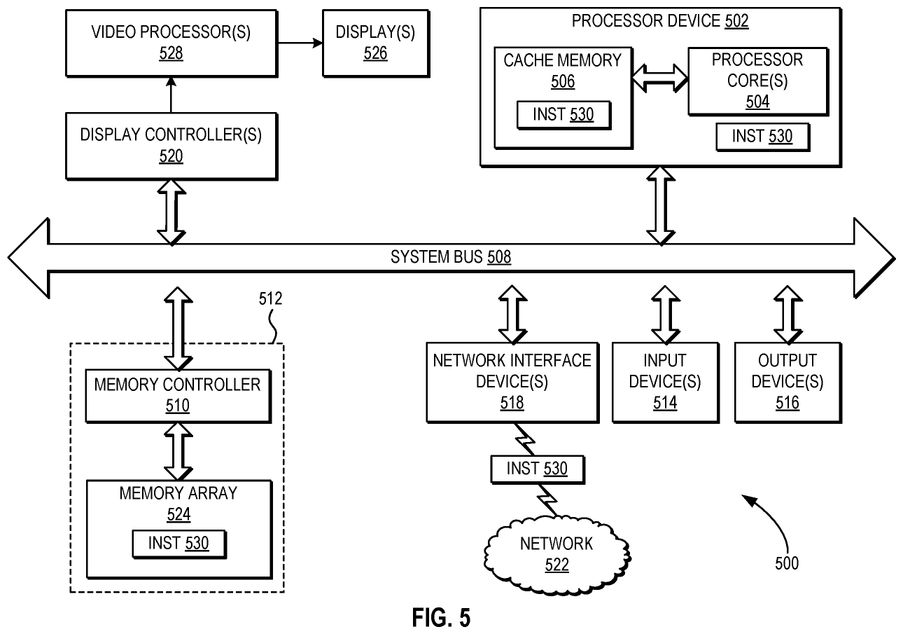

In this regard, FIG. 5 illustrates an example of a processor-based device 500. In this example, the processor-based device 500 includes a processor device 502, which corresponds in functionality to the processor device 200 of FIG. 2 and comprises one or more processor cores 504 coupled to a cache memory 506. The processor device 502 is also coupled to a system bus 508 and can intercouple devices included in the processor-based device 500. As is well known, the processor device 502 communicates with these other devices by exchanging address, control, and data information over the system bus 508. For example, the processor device 502 can communicate bus transaction requests to a memory controller 510. Although not illustrated in FIG. 5, multiple system buses 508 could be provided, wherein each system bus 508 constitutes a different fabric.

Other devices may be connected to the system bus 508. As illustrated in FIG. 5, these devices can include a memory system 512, one or more input devices 514, one or more output devices 516, one or more network interface devices 518, and one or more display controllers 520, as examples. The input device(s) 514 can include any type of input device, including, but not limited to, input keys, switches, voice processors, etc. The output device(s) 516 can include any type of output device, including, but not limited to, audio, video, other visual indicators, etc. The network interface device(s) 518 can be any devices configured to allow exchange of data to and from a network 522. The network 522 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 518 can be configured to support any type of communications protocol desired. The memory system 512 can include the memory controller 510 coupled to one or more memory arrays 524.

The processor device 502 may also be configured to access the display controller(s) 522 over the system bus 508 to control information sent to one or more displays 526. The display controller(s) 522 sends information to the display(s) 532 to be displayed via one or more video processors 528, which process the information to be displayed into a format suitable for the display(s) 526. The display(s) 526 can include any type of display, including, but not limited to, a cathode ray tube (CRT), a liquid crystal display (LCD), a plasma display, a light emitting diode (LED) display, etc.

The processor-based device 500 in FIG. 5 may include a set of instructions (captioned as “INST” in FIG. 5) 530 that may be executed by the processor device 502 for any application desired according to the instructions. The instructions 530 may be stored in the memory system 512, the processor device 502, and/or the cache memory 506, each of which may comprise an example of a non-transitory computer-readable medium. The instructions 530 may also reside, completely or at least partially, within the memory system 512 and/or within the processor device 502 during their execution. The instructions 530 may further be transmitted or received over the network 522, such that the network 522 may comprise an example of a computer-readable medium.

While the computer-readable medium is described in an exemplary embodiment herein to be a single medium, the term “computer-readable medium” should be taken to include a single medium or multiple media (e.g., a centralized or distributed database, and/or associated caches and servers) that store the set of instructions 530. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A processor device, comprising:
   a plurality of processing elements (PEs); and
   a low-power mode (LPM) selection circuit configured to:
      determine an average inter-processor interrupt (IPI) arrival interval for a PE of the plurality of PEs based on an IPI arrival history table for the PE;
      determine whether the average IPI arrival interval is greater than a minimum residency interval for a first LPM of the PE, wherein the first LPM is associated with lower power consumption and higher entry and exit latency relative to a second LPM of the PE;
   responsive to determining that the average IPI arrival interval is greater than the minimum residency interval for the first LPM, place the PE in the first LPM; and
   responsive to determining that the average IPI arrival interval is not greater than the minimum residency interval for the first LPM, place the PE in the second LPM.
2. The processor device of clause 1, wherein each PE of the plurality of PEs comprises a processor core.
3. The processor device of clause 1, wherein each PE of the plurality of PEs comprises a core cluster.
4. The processor device of any one of clauses 1-3, wherein:
   the first LPM comprises a power collapse LPM; and
   the second LPM comprises a clock gating LPM.
5. The processor device of any one of clauses 1-4, wherein the LPM selection circuit is further configured to:
   detect an IPI received by the PE;
   determine an IPI arrival interval for the IPI based on an arrival time of the IPI and an arrival time of a previous IPI; and
   store the IPI arrival interval in the IPI arrival history table for the PE.
6. The processor device of any one of clauses 1-5, wherein:
   the LPM selection circuit is further configured to identify an arrival interval pattern in the IPI arrival history table; and
   the LPM selection circuit is configured to determine the average IPI arrival interval for the PE responsive to identifying the arrival interval pattern in the IPI arrival history table.
7. The processor device of any one of clauses 1-6, wherein the LPM selection circuit is configured to place the PE in the first LPM by being configured to set an LPM interval for the first LPM to the lesser of the average IPI arrival interval and a next scheduled task interval.
8. The processor device of any one of clauses 1-7, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.
9. A method for selecting low-power modes (LPMs) based on monitoring inter-processor interrupt (IPI) arrival intervals in processor devices, comprising:
   determining, by an LPM selection circuit of a processor device, an average IPI arrival interval for a processing element (PE) of a plurality of PEs of the processor device based on an IPI arrival history table for the PE;
   determining, by the LPM selection circuit, that the average IPI arrival interval is greater than a minimum residency interval for a first LPM of the PE, wherein the first LPM is associated with lower power consumption and higher entry and exit latency relative to a second LPM of the PE; and
   responsive to determining that the average IPI arrival interval is greater than the minimum residency interval for the first LPM, placing, by the LPM selection circuit, the PE in the first LPM.
10. The method of clause 9, wherein each PE of the plurality of PEs comprises a processor core.
11. The method of clause 9, wherein each PE of the plurality of PEs comprises a core cluster.
12. The method of any one of clauses 9-11, wherein:
   the first LPM comprises a power collapse LPM; and
   the second LPM comprises a clock gating LPM.
13. The method of any one of clauses 9-12, further comprising:
   detecting, by the LPM selection circuit, an IPI received by the PE;
   determining, by the LPM selection circuit, an IPI arrival interval for the IPI based on an arrival time of the IPI and an arrival time of a previous IPI; and
   storing, by the LPM selection circuit, the IPI arrival interval in the IPI arrival history table for the PE.
14. The method of any one of clauses 9-13, wherein:
   the method further comprises identifying, by the LPM selection circuit, an arrival interval pattern in the IPI arrival history table; and
   determining the average IPI arrival interval for the PE is responsive to identifying the arrival interval pattern in the IPI arrival history table.
15. The method of any one of clauses 9-14, wherein placing the PE in the first LPM comprises setting an LPM interval for the first LPM to the lesser of the average IPI arrival interval and a next scheduled task interval.
16. A non-transitory computer-readable medium, having stored thereon computer-executable instructions that, when executed, cause a processor device to:
   determine an average inter-processor interrupt (IPI) arrival interval for a processing element (PE) of a plurality of PEs of the processor device based on an IPI arrival history table for the PE;
   determine whether the average IPI arrival interval is greater than a minimum residency interval for a first LPM of the PE, wherein the first LPM is associated with lower power consumption and higher entry and exit latency relative to a second LPM of the PE;
   responsive to determining that the average IPI arrival interval is greater than the minimum residency interval for the first LPM, place the PE in the first LPM; and
   responsive to determining that the average IPI arrival interval is not greater than the minimum residency interval for the first LPM, place the PE in the second LPM.
17. The non-transitory computer-readable medium of clause 16, wherein:
   the first LPM comprises a power collapse LPM; and
   the second LPM comprises a clock gating LPM.
18. The non-transitory computer-readable medium of any one of clauses 16-17, wherein the computer-executable instructions further cause the processor device to:
   detect an IPI received by the PE;
   determine an IPI arrival interval for the IPI based on an arrival time of the IPI and an arrival time of a previous IPI; and
   store the IPI arrival interval in the IPI arrival history table for the PE.
19. The non-transitory computer-readable medium of any one of clauses 16-18, wherein:
   the computer-executable instructions further cause the processor device to identify an arrival interval pattern in the IPI arrival history table; and
   the computer-executable instructions cause the processor device to determine the average IPI arrival interval for the PE responsive to identifying the arrival interval pattern in the IPI arrival history table.
20. The non-transitory computer-readable medium of any one of clauses 16-19, wherein the computer-executable instructions cause the processor device to place the PE in the first LPM by causing the processor device to set an LPM interval for the first LPM to the lesser of the average IPI arrival interval and a next scheduled task interval.

What is claimed is:

1. A processor device, comprising:
a plurality of processing elements (PEs); and
a low-power mode (LPM) selection circuit configured to:
determine an average inter-processor interrupt (IPI) arrival interval for a PE of the plurality of PEs based on an IPI arrival history table for the PE;
determine whether the average IPI arrival interval is greater than a minimum residency interval for a first LPM of the PE, wherein the first LPM is associated with lower power consumption and higher entry and exit latency relative to a second LPM of the PE;
responsive to determining that the average IPI arrival interval is greater than the minimum residency interval for the first LPM, place the PE in the first LPM; and
responsive to determining that the average IPI arrival interval is not greater than the minimum residency interval for the first LPM, place the PE in the second LPM.

2. The processor device of claim 1, wherein each PE of the plurality of PEs comprises a processor core.

3. The processor device of claim 1, wherein each PE of the plurality of PEs comprises a core cluster.

4. The processor device of claim 1, wherein:
the first LPM comprises a power collapse LPM; and
the second LPM comprises a clock gating LPM.

5. The processor device of claim 1, wherein the LPM selection circuit is further configured to:
detect an IPI received by the PE;
determine an IPI arrival interval for the IPI based on an arrival time of the IPI and an arrival time of a previous IPI; and
store the IPI arrival interval in the IPI arrival history table for the PE.

6. The processor device of claim 1, wherein:
the LPM selection circuit is further configured to identify an arrival interval pattern in the IPI arrival history table; and
the LPM selection circuit is configured to determine the average IPI arrival interval for the PE responsive to identifying the arrival interval pattern in the IPI arrival history table.

7. The processor device of claim 1, wherein the LPM selection circuit is configured to place the PE in the first LPM by being configured to set an LPM interval for the first LPM to the lesser of the average IPI arrival interval and a next scheduled task interval.

8. The processor device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.

9. A method for selecting low-power modes (LPMs) based on monitoring inter-processor interrupt (IPI) arrival intervals in processor devices, comprising:
determining, by an LPM selection circuit of a processor device, an average IPI arrival interval for a processing element (PE) of a plurality of PEs of the processor device based on an IPI arrival history table for the PE;
determining, by the LPM selection circuit, that the average IPI arrival interval is greater than a minimum residency interval for a first LPM of the PE, wherein the first LPM is associated with lower power consumption and higher entry and exit latency relative to a second LPM of the PE; and
responsive to determining that the average IPI arrival interval is greater than the minimum residency interval for the first LPM, placing, by the LPM selection circuit, the PE in the first LPM.

10. The method of claim 9, wherein each PE of the plurality of PEs comprises a processor core.

11. The method of claim 9, wherein each PE of the plurality of PEs comprises a core cluster.

12. The method of claim 9, wherein:
the first LPM comprises a power collapse LPM; and
the second LPM comprises a clock gating LPM.

13. The method of claim 9, further comprising:
detecting, by the LPM selection circuit, an IPI received by the PE;
determining, by the LPM selection circuit, an IPI arrival interval for the IPI based on an arrival time of the IPI and an arrival time of a previous IPI; and
storing, by the LPM selection circuit, the IPI arrival interval in the IPI arrival history table for the PE.

14. The method of claim 9, wherein:
the method further comprises identifying, by the LPM selection circuit, an arrival interval pattern in the IPI arrival history table; and
determining the average IPI arrival interval for the PE is responsive to identifying the arrival interval pattern in the IPI arrival history table.

15. The method of claim 9, wherein placing the PE in the first LPM comprises setting an LPM interval for the first LPM to the lesser of the average IPI arrival interval and a next scheduled task interval.

16. A non-transitory computer-readable medium, having stored thereon computer-executable instructions that, when executed, cause a processor device to:
determine an average inter-processor interrupt (IPI) arrival interval for a processing element (PE) of a plurality of PEs of the processor device based on an IPI arrival history table for the PE;
determine whether the average IPI arrival interval is greater than a minimum residency interval for a first LPM of the PE, wherein the first LPM is associated with lower power consumption and higher entry and exit latency relative to a second LPM of the PE;
responsive to determining that the average IPI arrival interval is greater than the minimum residency interval for the first LPM, place the PE in the first LPM; and
responsive to determining that the average IPI arrival interval is not greater than the minimum residency interval for the first LPM, place the PE in the second LPM.

17. The non-transitory computer-readable medium of claim 16, wherein:
the first LPM comprises a power collapse LPM; and
the second LPM comprises a clock gating LPM.

18. The non-transitory computer-readable medium of claim 16, wherein the computer-executable instructions further cause the processor device to:
detect an IPI received by the PE;
determine an IPI arrival interval for the IPI based on an arrival time of the IPI and an arrival time of a previous IPI; and
store the IPI arrival interval in the IPI arrival history table for the PE.

19. The non-transitory computer-readable medium of claim 16, wherein:
the computer-executable instructions further cause the processor device to identify an arrival interval pattern in the IPI arrival history table; and
the computer-executable instructions cause the processor device to determine the average IPI arrival interval for the PE responsive to identifying the arrival interval pattern in the IPI arrival history table.

20. The non-transitory computer-readable medium of claim 16, wherein the computer-executable instructions cause the processor device to place the PE in the first LPM by causing the processor device to set an LPM interval for the first LPM to the lesser of the average IPI arrival interval and a next scheduled task interval.
